(19) United States
(12) Patent Application Publication
(10) Pub. No.: US 2004/0177204 A1
(43) Pub. Date: Sep. 9, 2004

(54) Bus interface with variable resistance coupling

(76) Inventors: David C. Campbell, Gilbert, AZ (US); Anna Yee, Tempe, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/356,085

(22) Filed: Jan. 30, 2003

(51) Int. Cl. G06F 13/14

(52) U.S. Cl. 710/305

(57) ABSTRACT

An interface for coupling a device to a bus suitably includes a first resistive path having a first electrical resistance and a second resistive path having a second electrical resistance different from the first electrical resistance, with a switch configured to switchably couple the device to the bus via the first resistive path if the device operates at a first data rate, and to couple the device to the bus via the second resistive path if the device operates at a second data rate different from the first data rate. The interface may be used to provide an appropriate resistive coupling for devices that support conventional peripheral component interface (PCI) bus standards and/or PCI-X standards.

### FIELD OF THE INVENTION

The present invention generally relates to bus architectures for computing devices, and more particularly relates to interfaces between buses and other devices.

### BACKGROUND OF THE INVENTION

As computing systems such as personal computers continue to permeate every aspect of personal and professional life, the need for faster interconnection technologies suitably increases. Bus architectures in particular have evolved at a very rapid pace, with newer technologies providing ever-increasing throughput and faster data speeds. The peripheral components interface (PCI) bus architecture, for example, has become widely accepted as a standard technique for interconnecting multiprocessors, memory, input/output cards, and the like within personal computers. Nevertheless, “PCI-X” equipment that provides significantly greater throughput than conventional PCI is becoming more popular. “Conventional PCI”, “PCI-X” and other PCI-related standards are described in various publications provided by the PCI Special Interest Group (PCI-SIG) of Portland, Oreg. Other bus technologies include the VMEbus architecture, the advanced graphics port (AGP) architecture and others. Each of these bus architectures typically provides a hardware scheme and an associated signaling protocol for transmitting data on the bus. Typically, each bus includes multiple carriers (e.g. wires or other electrical conductors) between the various components such that data is rapidly transmitted in parallel to improve throughput. The conventional PCI bus architecture, for example, typically specifies 32 separate address/data bus lines, thereby allowing 32 bits of digital data to be simultaneously transmitted from one component to another. Other bus architectures support simultaneous transmission of 16, 64, 128 or more bits of simultaneous data.

As bus architectures provide improved capability, problems frequently arise with regard to backward compatibility. That is, new bus technologies are frequently incompatible with older technologies, thus requiring users to purchase and install updated equipment that is compatible with the newer bus technology. One backward-compatibility problem arises, for example, when high-speed PCI-X equipment is incorporated into conventional PCI architectures, or vice versa. This problem arises in that PCI-X standards typically require that certain pins (for example, the device select pin IDSEL) be resistively coupled to one of the bus address lines using a two K-ohm resistor. Although conventional PCI does not specify a particular valve for the coupling resistor, values of approximately 220 ohms have frequently been used in practice. Because conventional PCI and PCI-X have conflicting resistance needs on the same IDSEL pin, many products are able to support one technology or the other, but not both simultaneously. More recently, products purporting to support both conventional PCI and PCI-X technologies do so by providing a resistor that can be modified by the user. Changing the resistance between the address pins, however, typically involves removing a resistor and re-soldering a new resistor in its place. Because this process requires relatively specialized equipment and skill, it is beyond the grasp of most ordinary users, and may result in damage to the equipment if not performed properly. Accordingly, although many PCI products have been developed for either conventional PCI or PCI-X, most of these products do not readily support both technologies simultaneously.

A need therefore exists for a bus coupling technology that supports high-speed data transfer rates while supporting legacy technologies without the need for hardware modification. In addition, it is desirable to create an interface that is easily implemented, that readily adapts to technologies in use, and that is useable with multiple bus technologies. Furthermore, other desirable features and characteristics of the present invention will become apparent from the subsequent detailed description of the invention and any appended claims, taken in conjunction with the accompanied drawings and this background of the invention.

### BRIEF DESCRIPTION OF THE DRAWINGS

The present invention will hereinafter be described in conjunction with the following drawing figures, wherein like numerals denote like elements, and

FIG. 1 is a block diagram of an exemplary computing system;

FIG. 2 is a block diagram of an exemplary interface; and

FIG. 3 is a circuit diagram of an exemplary interface.

### DETAILED DESCRIPTION OF THE DRAWINGS

The following detailed description of the invention is merely exemplary in nature and is not intended to limit the invention or the application and uses of the invention. Furthermore, there is no intention to be bound by any theory presented in the preceding background of the invention or the following detailed description of the drawings.

According to various embodiments of the invention, a new interface technology is provided for coupling a daughter card or other computing device to a bus. The interface suitably includes multiple resistive paths between the device and the bus, with one or more switches provided to select the appropriate path for the device based upon the particular bus technology, data rate, and/or other factors. In a PCI embodiment supporting both conventional PCI and PCI-X, for example, a high-resistance connection and a low-resistance connection between the device and the bus are provided in parallel, with an analog switch selecting the appropriate resistive path for data transmitted at a particular data rate. High speed data may be transferred via the high-resistance path, for example, while lower-speed data is transferred via the lower-resistance path.

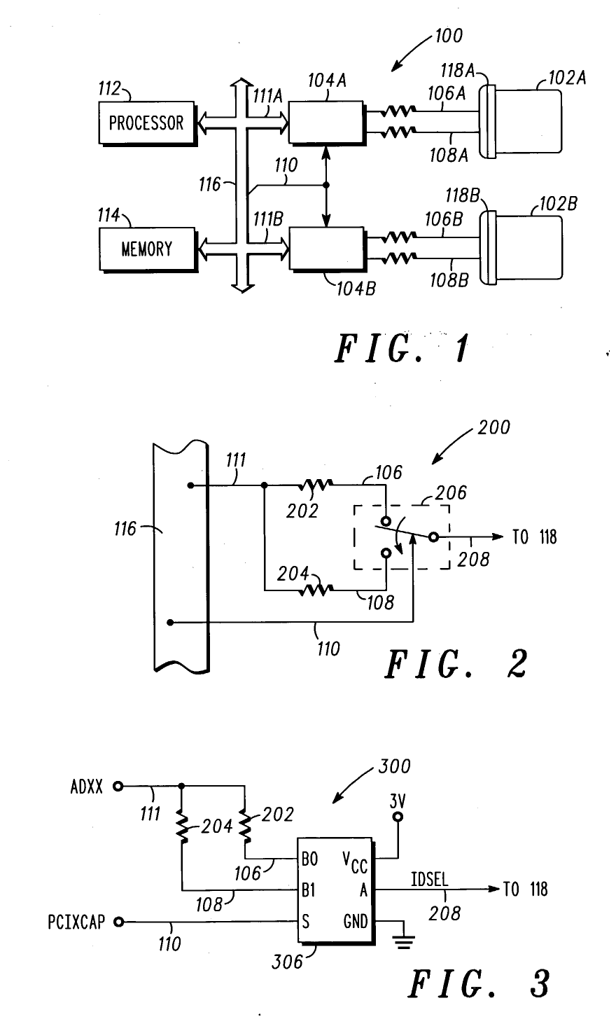

With reference to FIG. 1, an exemplary computing system 100 suitably includes a microprocessor 112, a memory 114, and the one or more interfaces 118A-B to an external device 102A-B intercommunicating via a data bus 116. Each interface 118A-B is suitably connected to data bus 116 via a switch 104A-B that appropriately connects a bus connect line 111A-B to one of several data paths 106A-B or 108A-B, which are in turn connected to interface 118A-B. Switches 104A-B suitably receive control signal 110 from data bus 116 or another appropriate source to place switches 104A-B into an appropriate state such that the interfaces 118A-B are coupled to data bus 116 with the proper resistive coupling for the type of data transferred across bus connect lines 111A-B. In one embodiment, computing system 100 is a personal computer using a conventional microprocessor 112 and appropriate digital memory 114 as well as any conventional bus architecture for data bus 116. In another embodiment, computing system 100 is an embedded system, a single-board computer for a backplane-type system, or any other computing system that interfaces with a daughter card, processing board or other device 102.

Data bus 116 is any data and/or address bus that is capable of transmitting data between processor 112, memory 114, and/or interfaces 118A-B. In various embodiments bus 116 is a peripheral component interface (PCI) bus, although in other embodiments other bus architectures such as the VMEbus, advanced graphics port (AGP) or any other bus architecture could be used. In further embodiments, bus 116 includes multiple buses interconnected by various bridges, gateways, and the like. In such embodiments, the various inter-combined bus architectures may or may not be identical to each other. For example, a VME bus interconnecting processor 112 and memory 114 may be bridged to a separate PCI bus coupling processor 112 to interfaces 118A-B, or the like.

Interfaces 118A-B are any interfaces, ports, slots or the like capable of connecting an external device 102A-B to computing system 100. In an exemplary embodiment, interfaces 118A-B are slots for accepting daughter cards or other processing devices 102A-B intended to be interfaced with computing system 100. Various daughter cards used as devices 102A-B might include input/output cards, video processing cards, audio processing cards, or the like. In various embodiments, devices 102A-B are compatible with the PCI specifications set forth by the PCI Industrial Computer Manufacturers Group (PICMG) and are capable of operating at either conventional PCI speeds and/or at PCI-X speeds. As defined more fully below, switches 104A-B appropriately connect interfaces 118A-B to data bus 116 via the appropriate resistive paths 106A-B or 108A-B as determined by the particular bus standard and/or data transfer rate(s) supported by devices 102A-B.

With reference now to FIG. 2, an exemplary interface 200 between data bus 116 and an external device (such as a daughter card) 118 typically includes a low resistance path 106 and a high resistance path 108 switchably connected to an output path 208 by switch 206. In various embodiments, path 106 includes a relatively low resistive value for resistor 202 to correspond to relatively low-speed data connections, such as those used in conventional PCI implementations. Path 108 typically includes a relatively high resistance for resistor 204 to provide an appropriate data path for high speed signals such as PCI-X signals. The higher resistance value provided by resistor 204 appropriately reduces the load on address pin 111, thus resulting in reduced capacitance on bus 116 and improved throughput. Conversely, the lower resistance value for resistor 202 provides support for legacy technologies. Switch 206 is any analog switch capable of receiving a control input 110 and of switchably adjusting the state of switch 206 in response to control signal 110 to connect address pin 111 to output path 208 via the appropriate resistive path 106 or 108. Control signal 110 is any digital or analog signal that is capable of placing switch 206 into the appropriate state to provide the desired resistive coupling between device 102 and bus 116. In an exemplary embodiment, control signal 110 is generated by digital logic coupled to each device 102 communicating on bus 116. Alternatively, control signal 110 may emanate from processor 104 (FIG. 1), from a signal on bus 116, from device 102, or from any other source.

With reference now to FIG. 3, an exemplary interface 300 suitable for coupling a device select (IDSEL) signal to an address line 111 suitably includes an analog switch 306 receiving a control signal 110 to select between high resistance path 106 and low-resistance path 108. As computing system 100 (FIG. 1) determines whether the system is capable of operating at high speeds, control signal 110 is appropriately generated and provided to switch 306. This digital control signal 110 can be used to place the appropriate high resistance 202 or low resistance 204 into the coupling path between IDSEL 208 and address line 111.

Switch 306 is any digital or analog switch, circuit, relay, or the like capable of implementing an analog switch function. In an exemplary embodiment, switch 306 is implemented with a model NC7SV3157 switch available from the Fairchild Semiconductor Corporation of San Jose, Calif. Alternatively, switch 306 could be implemented with a model NLASB3157 two-to-one multiplexer available from the ON Semiconductor Corporation of Phoenix, Ariz. Either of these components (as well as many other similar switches) are capable of selecting an analog path 106 or 108 based upon a digital signal provided to a select input. Switch 306 may also receive a bias voltage V_{cc} and a reference signal (GND), as shown in FIG. 3.

According to conventional PCI and PCI-X specifications, an initialization device select (IDSEL) signal 208 is appropriately used as a chip select signal while the PCI system is being configured (e.g. immediately after power-up). The IDSEL signal allows the bus master or other configuring mechanisms to individually address each device communicating on bus 116. According to PCI specifications, the IDSEL pin is resistively coupled to one of the PCI address/data pins AD31-AD26 corresponding to a unique number for each device communicating on bus 116. As briefly mentioned above, the coupling resistance values for conventional PCI and PCI-X standards differ by an order of magnitude or more. The PCI-X standard, for example, mandates that a serial resistance 202 of 2 k ohms within a tolerance of about 5 percent or 100 Ohms be provided. As used herein, a resistance of “substantially 2 k ohms” typically lies within the 5 percent tolerance mandated by the PCI-X specification, and is intended to cover additional resistance variations due to manufacturing and design fluctuations, imperfections and the like. Similarly, conventional PCI implementations generally include a serial resistance between the IDSEL pin 208 and address line 111 of about 220 ohms. Again, this resistance may vary somewhat from embodiment to embodiment, and the term “substantially equal to 220 k ohms” is intended to encompass any resistance value used in resistively coupling conventional PCI IDSEL 208 signals to address lines 111, including values within about ten percent tolerance of the 220 ohm value described above.

The control input 110 to switch 306 is a function of the PCIXCAP signal defined by the PCI-X specification for determining the speed and operating mode of cards attached to PCI bus 116. PCIXCAP is typically derived using comparative logic within computer system 100 (FIG. 1) and may be provided along bus 116, or as an extraneous signal within computing system 100. In a typical PCI implementation, each device coupled to a PCI bus 116 suitably identifies its maximum operating speed according to the impedance placed on the PCIXCAP pin of the PCI bus 116. In conventional PCI, this pin location is designated as a ground connection. Accordingly, if any of the devices communicating on bus 116 couple PCIXCAP to ground, appropriate comparator logic can readily determine that only conventional PCI speeds can be used on bus 116. PCI-X implementations operating at 133 MHz leave the PCIXCAP pin as a relatively open circuit, coupling the pin to ground using only a de-coupling capacitor of about 10 pF. Other implementations of PCI-X place a 10 k ohm resistor in parallel with the decoupling capacitor to indicate that the card is capable of transmitting at intermediate PCI-X speeds of 66 MHz. Accordingly, comparator logic on computing system 100 or another appropriate host is able to determine the lowest common dominator of transmission speeds on the PCI bus 116 by simply measuring the voltage on the PCIXCAP pin. If all of the devices 102A-B are capable of transmitting at 133 MHz, the voltage on PCIXCAP will be pulled up to V_{cc}, which may be on the order of about three volts in many embodiments. If the slowest device 102A-B is capable of intermediate PCI-X speed, the voltage on the PCIXCAP pin will be an intermediate value between ground and V_{cc} due to the 10 k ohm resistor placed in series with the pin. Finally, if the PCIXCAP is grounded, then only conventional PCI speeds are available on bus 116. Control signal 110 is therefore set to an appropriate digital value in response to the PCIXCAP signal to indicate whether PCI-X capabilities are valid on bus 116 or not. Control signal 110 may be coupled to the PCIXCAP pin through a series of logic gates to compute the appropriate control values based upon PCIXCAP, or in some embodiments the PCIXCAP signal may be provided directly as control signal 110. In an exemplary embodiment, control signal 110 has a logically low (i.e. “zero”) value if only conventional PCI signaling is available, and a logically high (i.e. “one”) value if PCI-X capabilities are available. Accordingly, control signal 110 suitably acts as a digital indicator of the appropriate data transfer speed for bus 116.

In operation, then, control signal 110 may be provided as a digital switching input to switch 306 to appropriately place either resistor 202 or resistor 204 in serial connection between IDSEL pin 208 on device 102 and address line 111. In such embodiments, the appropriate resistive coupling value is placed into the interface circuit, without the need for significant additional digital processing. Accordingly, interface 300 is able to support multiple data speeds without requiring reconfiguration of hardware, re-soldering or the like.

While an exemplary embodiment(s) has been presented in the foregoing detailed description of the invention, it should be appreciated that a vast number of variations and equivalents exist. For example, while certain aspects of the invention have been described herein with reference to PCI bus standards, the concepts disclosed herein may be readily adapted to other port or interface specifications such as Future I/O, Next Generation I/O, accelerated graphics port (AGP), universal serial bus (USB), VMEbus, or any other bus or interface. Further, the concepts described herein with respect to resistive coupling could be used in equivalent embodiments using capacitive coupling or the like. It should be appreciated that these exemplary embodiments are only examples, and are not intended to limit the scope, applicability, or configuration of the invention in any way. Rather, the foregoing detailed description will provide a convenient road map for implementing exemplary embodiments of the invention. Various changes may be made in the function and arrangement of elements described in any of the exemplary embodiments without departing from the scope of the invention as set forth in the appended claims and their legal equivalents.

What is claimed is:

1. An interface for coupling a device to a bus, the coupler comprising:
a first resistive path having a first electrical resistance;
a second resistive path having a second electrical resistance different from the first electrical resistance; and
a switch configured to switchably couple the device to the bus via the first resistive path if the device operates at a first data rate, and to couple the device to the bus via the second resistive path if the device operates at a second data rate different from the first data rate.

2. The interface of claim 1 wherein the switch is further configured to receive a control signal from the device and to translate the switch in response thereto.

3. The interface of claim 1 wherein the first electrical resistance is greater than the second resistance, and wherein the first data rate is greater than the second data rate.

4. The interface of claim 3 wherein the first resistance is substantially equal to 2000 ohms.

5. The interface of claim 4 wherein the second resistance is less than 500 ohms.

6. The interface of claim 5 wherein the second resistance is substantially equal to 220 ohms.

7. A circuit for coupling a device to a bus within a computing system, the circuit comprising:
a first resistive path between the device and the bus, the first resistive path having a first electrical resistance;
a second resistive path between the device and the bus, the second resistive path having a second electrical resistance that is less than the first electrical resistance; and
an analog switch receiving having a first input coupled to the bus, a second input configured to receive a control signal, a first output coupled to the first resistive path, and a second output coupled to the second resistive path, wherein the analog switch is operable to switchably connect the first input to either of the first output or the second output as a function of the control signal.

8. The circuit of claim 7 wherein the control signal is determined as a function of the data rate of the device.

9. The circuit of claim 8 wherein the control signal is provided by the computing host.

10. The circuit of claim 8 wherein the control signal is provided by the device.

11. A computing system having a bus interconnecting a processor, a memory and an interface to an external device, the interface comprising:
a first resistive path having a first electrical resistance;
a second resistive path having a second electrical resistance different from the first electrical resistance; and
a switch configured to switchably couple the device to the bus via the first resistive path if the device operates at a first data rate, and to couple the device to the bus via the second resistive path if the device operates at a second data rate different from the first data rate.

12. An interface for coupling a device to a bus within a computing host, the interface comprising:
means for receiving the device at an interface having a high resistance path and a low resistance path;
means for determining a data rate of the device; and
means for selecting the high resistance path or the low resistance path for coupling the device to the bus as a function of the data rate of the device.

13. A method of coupling a device to an address bus, the method comprising the steps of:
receiving the device at an interface having a high resistance path and a low resistance path;
determining a data rate of the device; and
coupling the device to the bus via the high resistance path or the low resistance path as a function of the data rate of the device.

14. The method of claim 13 wherein the determining step comprises measuring a voltage of an electrical signal received from the device to determine a resistance provided by the device, wherein the resistance is indicative of the data rate of the device.

15. The method of claim 14 wherein the determining step further comprises providing a digital signal in response to the measuring step.

16. The method of claim 15 wherein the coupling step comprises receiving the digital signal at a control input of a switch coupled to the high resistance path and the low resistance path.
